(19) United States
(12) Patent Application Publication
(10) Pub. No.: US 2022/0284536 A1
(43) Pub. Date: Sep. 8, 2022

(54) METHODS AND APPARATUS FOR INCREMENTAL RESOURCE ALLOCATION FOR JANK FREE COMPOSITION CONVERGENCE

(71) Applicant: QUALCOMM Incorporated, San Diego, CA (US)

(72) Inventors: Mahesh AIA, San Diego, CA (US); Dileep MARCHYA, Hyderabad (IN)

(21) Appl. No.: 17/190,318

(22) Filed: Mar. 2, 2021

(51) Int. Cl. G06T 1/20; G06F 9/50; G09G 5/36

(52) U.S. Cl. CPC G06T 1/20; G06F 9/5066; G09G 5/363

(57) ABSTRACT

The present disclosure relates to methods and apparatus for display processing, the apparatus configured to identify an adjustment in one or more layers of a plurality of layers in a current frame compared to layers of a plurality of layers in a previous frame; to determine, upon identifying the adjustment in the one or more layers, a first resource allocation for each of the plurality of layers; to determine, after the determination of the first resource allocation begins, a second resource allocation for each of the plurality of layers; to initiate, upon determining the first resource allocation, an execution of the composition process for each layer in the current frame based on the first resource allocation; and to initiate, upon determining the second resource allocation, an execution of the composition process for each of the layer in at least one subsequent frame based on the second resource allocation.

### TECHNICAL FIELD

The present disclosure relates generally to processing systems and, more particularly, to one or more techniques for display processing.

### INTRODUCTION

Computing devices often perform graphics and/or display processing (e.g., utilising a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or DPU may be configured to perform the processes of display processing. However, with the advent of wireless communication and smaller, handheld devices, there has developed an increased need for improved graphics or display processing.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a central processing unit (CPU), a graphics processing unit (GPU), a display processing unit (DPU) or any apparatus that can perform display processing. The apparatus may be configured to identify an adjustment in one or more layers of a plurality of layers in a current frame compared to one or more layers of a plurality of layers in a previous frame. The apparatus may further be configured to determine, upon identifying the adjustment in the one or more layers, a first resource allocation for each of the plurality of layers, the first resource allocation being associated with a composition process for the plurality of layers. The apparatus may also be configured to determine, after the determination of the first resource allocation begins, a second resource allocation for each of the plurality of layers, the second resource allocation being associated with the composition process for the plurality of layers. The apparatus may be additionally configured to initiate, upon determining the first resource allocation, an execution of the composition process for each of the plurality of layers in the current frame based on the first resource allocation. The apparatus may further be configured to initiate, upon determining the second resource allocation, an execution of the composition process for each of the plurality of layers in at least one subsequent frame based on the second resource allocation.

In some aspects, the apparatus may be configured to receive a query associated with the composition process based on the second resource allocation, and the execution of the composition process for each of the plurality of layers in the at least one subsequent frame based on the second resource allocation may be initiated based on the query. The apparatus may further be configured to transmit, in response to the query, an instruction for the execution of the composition process for each of the plurality of layers in the at least one subsequent frame based on the second resource allocation.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3A includes a diagram illustrating a set of composition operations performed for a first set of frames at a first frame rate.

FIG. 3B includes a diagram illustrating a set of composition operations for a second set of frames at a second frame rate.

FIG. 4 illustrates an example diagram including a set of composition operations for a set of frames at a particular frame rate.

FIG. 5 is a call flow diagram illustrating a set of operations performed by a compositor for composing a set of layers of a frame after a geometry change.

FIG. 6 is a flowchart of an example method of display processing in accordance with one or more techniques of this disclosure.

### DETAILED DESCRIPTION

A number of methods and apparatuses can be used to perform display processing for a display using a high refresh rate without jank or other display degradation based on the high refresh rate. For example, the methods and apparatuses may perform incremental overlay resource allocation (e.g., a phased composition strategy or a two-pass overlay resource allocation) to simultaneously achieve jank-free user experience and a power-optimal DPU composition resource allocation after a geometry change. A first overlay resource allocation operation (e.g., a first phase/pass) may determine a DPU composition resource allocation that may not be power-optimal for composition of the layers identified after a geometry change, but may be less time-consuming to determine than a determination of a power-optimal DPU composition resource allocation. The first overlay resource allocation determination may be applied to (or implemented for) composition of a first frame after a geometry change. A second overlay resource allocation operation (e.g., a second phase/pass) after the geometry change, which may complete after a hardware (HW) vertical synchronization (HW Vsync) subsequent to the geometry change, may determine a power-optimal DPU composition resource allocation for composition of the layers identified after a geometry change that may be applied to (e.g., implemented for) subsequent frames after applying the first overlay resource allocation determination to the first frame after the geometry change.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

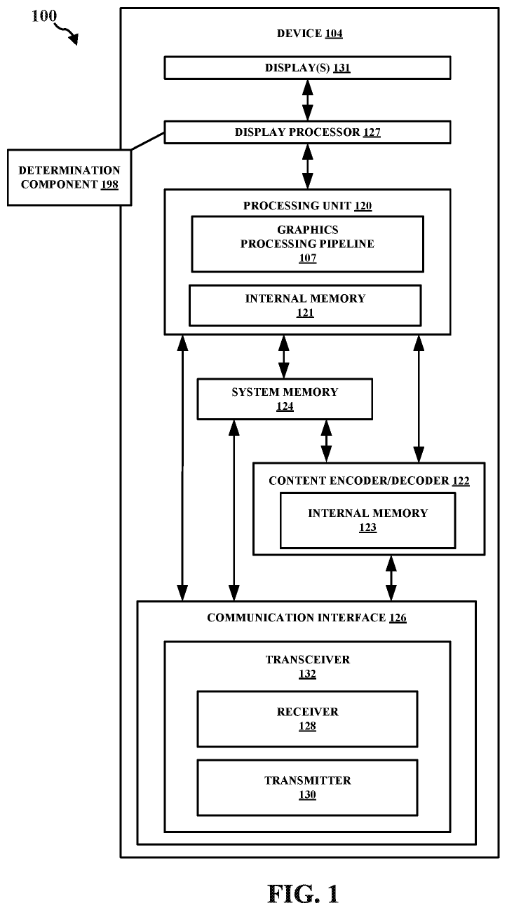

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 can include a number of optional components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this can be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 can include an optional communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the display processor 127 may include a determination component 198 configured to identify an adjustment in one or more layers of a plurality of layers in a current frame compared to the one or more layers of the plurality of layers in a previous frame. The determination component 198 may also be configured to determine, upon identifying the adjustment in the one or more layers, a first resource allocation for each of the plurality of layers, the first resource allocation being associated with a composition process for the plurality of layers. The determination component 198 may further be configured to determine, after the determination of the first resource allocation begins, a second resource allocation for each of the plurality of layers, the second resource allocation being associated with the composition process for the plurality of layers. The determination component 198 may additionally be configured to initiate, upon determining the first resource allocation, an execution of the composition process for each of the plurality of layers in the current frame based on the first resource allocation. The determination component 198 may also be configured to initiate, upon determining the second resource allocation, an execution of the composition process for each of the plurality of layers in at least one subsequent frame based on the second resource allocation. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, can be performed using other components (e.g., a CPU), consistent with disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit that indicates which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

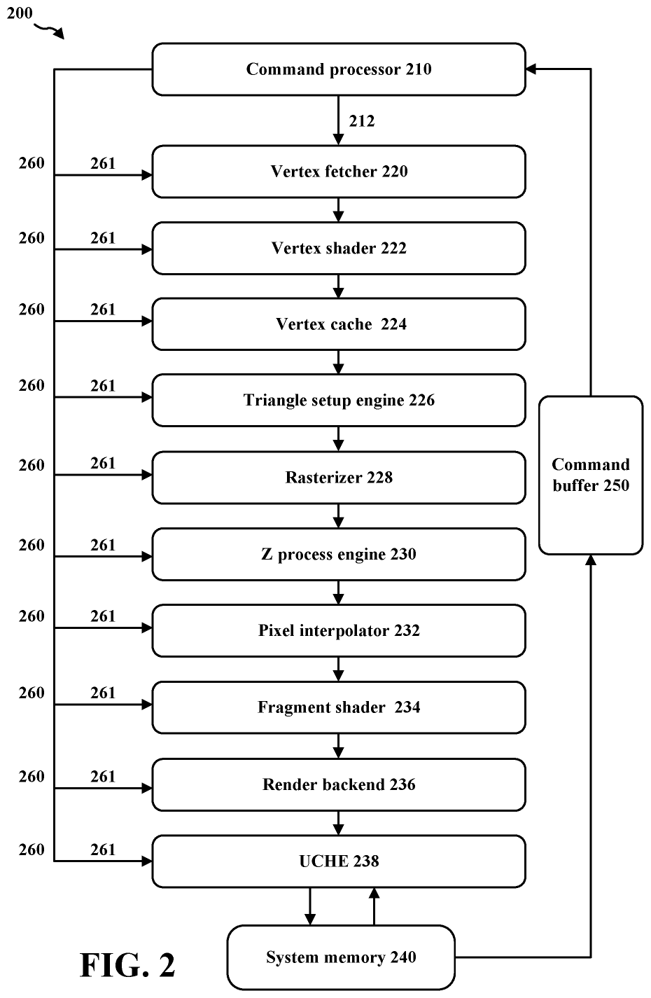

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can be structured in the following manner: context register of context N, draw call(s) of context N, context register of context N+1, and draw call(s) of context N+1.

In some aspects of display processing, devices may perform display composition with a compositor. The term compositor, as used herein, includes any hardware or software components of a device (e.g., device 104) that perform operations relating to frame composition. In one aspect, the compositor may include frontend and backend components, i.e., a frontend and a backend. The backend components may determine a resource allocation for composing a set of layers of a frame, while the frontend component of the compositor may perform the composition of layers of a frame based on the determined resource allocation. In some configurations, both the frontend and backend may include software and/or hardware resources. In some aspects, determining a resource allocation (e.g., by a backend component) may include determining, for each new frame geometry, which layers (or frame components) should be composed by a first set of resources associated with the compositor (e.g., DPU resources such as pipes, mixers, bandwidth, clocks, etc.) and which layers should be composed by a second set of resources associated with the compositor (e.g., CPU and/or GPU resources). The composition decision may then be implemented by the first and second sets of resources (e.g., processing unit 120, system memory 124, display processor 127, etc. of device 104) associated with the compositor components.

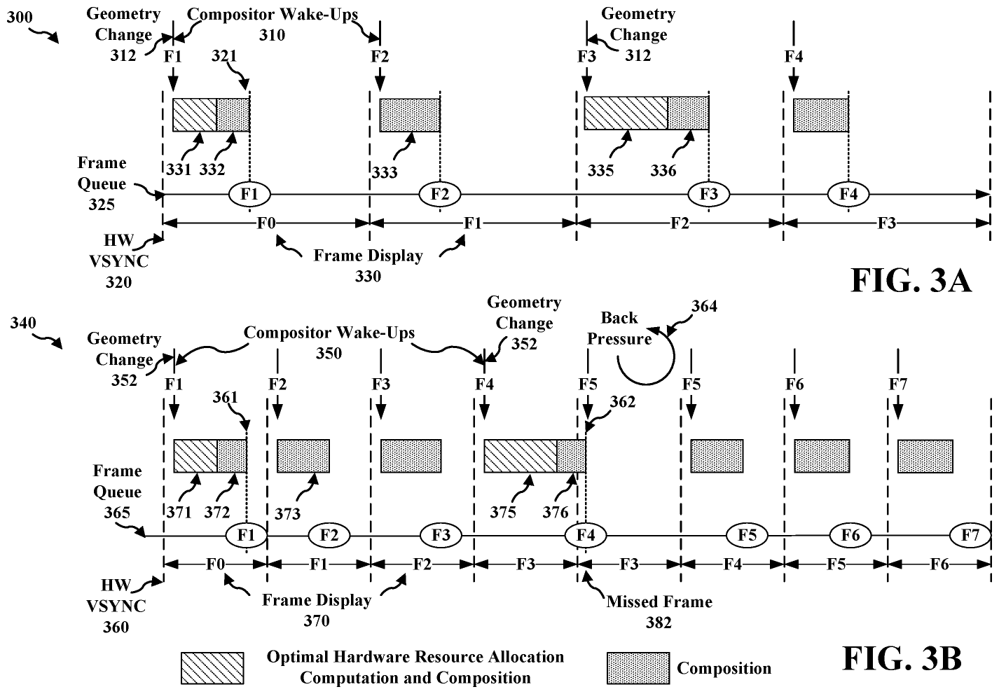

FIG. 3A includes a diagram 300 illustrating a set of composition operations performed for a first set of frames (e.g., F1-F4) at a first frame rate (e.g., 120 Hz). FIG. 3B includes a diagram 340 illustrating a set of composition operations for a second set of frames at a second frame rate (e.g., 240 Hz). FIG. 3A illustrates a set of frames F1-F4 that are identified at compositor wake-up times 310 (i.e., compositor wake-ups). Some frames (e.g., frames F1 and F3) may have a geometry change 312 when compared to a previous frame. Geometry change 312 may be any of a change in the dimensions of a particular layer, a change in the number or identities (e.g., associated applications) of layers in the frame, or a change in a relative z-order of layers. FIG. 3A illustrates a HW Vsync 320 indicating a time at which display hardware updates a displayed frame 330 from a previously displayed frame to a frame in frame queue 325.

FIG. 3A further illustrates that a geometry change 312 is identified by the compositor for a first frame (F1). Based on the geometry change 312, the compositor (e.g., a backend component) may determine a resource allocation for the layers of frame F1 during interval 331 and may initiate a composition process for composing the layers of frame F1 during interval 332 based on the resource allocation determination during interval 331 and, at a time indicated by dashed line 321, may complete the composition of frame F1 for inclusion in the frame queue 325. At the next HW Vsync, the frame F1 may be transmitted to a display. For a next frame (F2) there may be no geometry change identified and the resource allocation determined for frame F1 may be used to compose the layers of frame F2 during time interval 333. Time interval 333 for composing frame F2 may be shorter than time intervals 331 and 332 for determining a resource allocation for, and composing, frame F1. Time interval 333 may be shorter than time intervals 331 and 332 because the compositor may compose frame F2 based on the resource allocation determined for F1 and may not perform an additional resource allocation determination for processing frame F2. Frames F3 and F4 may have a similar set of associated operations as frames F1 and F2. As illustrated, time intervals 335 and 336 may be longer than time interval 331, but as long as the frame is composed before the next HW Vsync, the frame F3 may be available to be displayed.

In some configurations, the compositor or compositor backend may make a composition decision (e.g., a resource allocation determination) on every draw cycle (e.g., every Vsync cycle or every frame) based on a set of one or more layers in a frame (e.g., a plurality layers identified by the compositor and provided to the compositor backend). The composition decision may determine an optimal (e.g., power-optimal) resource allocation of resources available for composition (e.g., DPU resources, GPU resources, or CPU resources) to compose each layer of the layers in the frame. For example, given a set of layers, DPU resources may be allocated to compose a first subset of layers in the frame, GPU resources may be allocated to compose a second subset of layers in the frame, and CPU resources may be allocated to compose a third subset of layers in the frame. The resource allocation determination may also include determining a clock bandwidth and/or hardware resources allocated to each layer. For a particular draw cycle (e.g., frame) which has a same set of one or more layers as an immediately previous draw cycle (e.g., frame F2), the composition decision may be to use a resource allocation determined to be optimal for the immediately previous draw cycle (e.g., frame F1).

FIG. 3B includes diagram 340 illustrating a set of composition operations for a second set of frames at a second frame rate (e.g., 240 Hz). FIG. 3B illustrates a set of frames F1-F7 that are identified at compositor wake-ups 350. Some frames (e.g., frames F1 and F4) may have a geometry change 352 when compared to a previous frame. Geometry change 352 may be any of a change in the dimensions of a particular layer, a change in the number or identities (e.g., associated applications) of layers in the frame, or a change in a relative z-order of layers. FIG. 3B illustrates a HW Vsync 360 indicating a time at which display hardware updates a displayed frame 370 from a previously displayed frame to a frame in frame queue 365. As illustrated in FIG. 3B, the time between HW Vsyncs in diagram 340 may be shorter than the time between HW Vsyncs in diagram 300 based on the second frame rate being faster (e.g., 240 Hz vs. 120 Hz).

FIG. 3B further illustrates that a geometry change 352 may be identified by the compositor for a first frame (F1). Based on the geometry change 352, the compositor (e.g., a compositor backend component) may determine a resource allocation for the layers of frame F1 and may initiate a composition process during the interval 372 for composing the layers of frame F1 based on the resource allocation determination during interval 371 and, at a time indicated by dashed line 361, may complete the composition of the layers of frame F1 for inclusion in the frame queue 365. At the next HW Vsync, the frame F1 may be transmitted to a display. For subsequent frames (F2 and F3) there may be no geometry change identified and the resource allocation determined for frame F1 may be used to compose the layers of subsequent frames (e.g., frame F2 may be composed using the resource allocation determined for frame F1 during time interval 373). Time interval 373 for composing frame F2 may be shorter than time intervals 371 and 372 for determining a resource allocation for, and composing, frame F1. As discussed in relation to FIG. 3A, time interval 373 may be shorter than time intervals 371 and 372 because the compositor composes the layers of frame F2 based on the resource allocation determined for F1 and may not perform an additional resource allocation determination for processing frame F2. Frames F4 and F5 may have a similar set of associated operations as frames F1 and F2, respectively.

At frame F4, another geometry change may be identified and the compositor (e.g., a compositor backend component) may determine a resource allocation for the layers of frame F4 during time interval 375. As shown, the time intervals 375 and 376 (for determining a resource allocation 375 and a composition process based on the determined resource allocation 376) may extend to time 362 which is beyond a time at which the next HW Vsync occurs. Missed frame 382 may be the result of frame F4 not being composed and entered into the frame queue 365 before the HW Vsync. Accordingly, frame F3 may continue to be displayed at frame display 370. In some aspects, there may be back pressure 364 that specifies frame F5 to be resubmitted for composition. Other embodiments may skip frame F5 and proceed to frame F6. In either case, a user of the display output may notice video degradation (e.g., jank, frame skipping, etc.). As shown, the determined resource allocation made during time interval 375 may be used to compose the layers of frames F5, F6, and F7 based on a consistent geometry (e.g., no geometry changes between F4 and F7) and no more frames being missed.

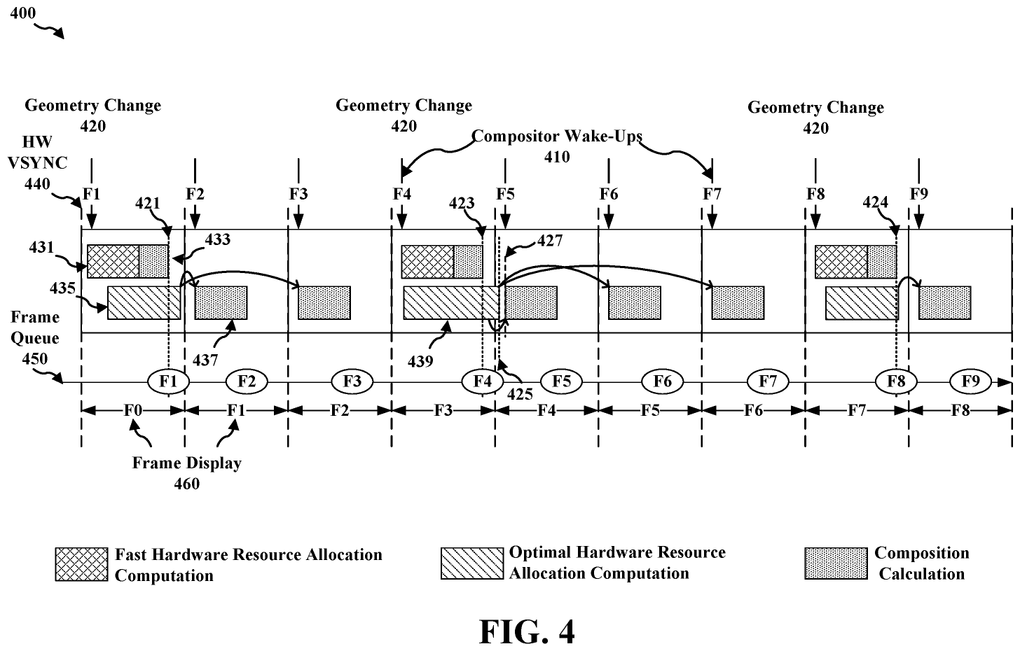

FIG. 4 illustrates an example diagram 400 including a set of composition operations for a set of frames at a particular frame rate (e.g., 240 Hz). FIG. 4 illustrates a set of frames F1-F9 that are identified at compositor wake-ups 410. Some frames (e.g., frames F1, F4, and F8) may have a geometry change 420 when compared to a previous frame. Geometry change 420 may be any, or all, of a change in the dimensions of a particular layer, a change in the number or identities (e.g., associated applications) of layers in the frame, or a change in a relative z-order of layers, and/or any other difference between layers of a previous frame and a current frame that affect an optimal composition resource allocation. FIG. 4 illustrates a HW Vsync 440 indicating a time at which display hardware updates a displayed frame 460 from a previously displayed frame to a frame in frame queue 450.

FIG. 4 illustrates that, upon a geometry change 420, the compositor of some configurations may identify the geometry change 420 and perform a first resource allocation determination during a time period 431 to determine a first resource allocation for each of a plurality of layers in the current frame. The first resource allocation determined during time interval 431, in some configurations, may be a fast resource allocation, i.e., a resource allocation that may not be optimal. Upon determining the first resource allocation, the execution of a composition process 433 for each of the plurality of layers may be initiated based on the first resource allocation. As illustrated, determining the first resource allocation 431 and executing the composition process 433 may be completed at a time 421 that is before a next HW Vsync 440, such that the frame may be ready to be displayed at the next HW Vsync 440.

Additionally, based on the identification of the geometry change 420, the compositor of some configurations may perform a second resource allocation determination during time period 435 to determine a second resource allocation for each of a plurality of layers in a current frame. The second determination operation 435 may begin before, after, or simultaneously with the first determination operation 431. The second resource allocation may be an optimal (or optimized) resource allocation for each of a plurality of layers in the current frame. The second, optimal resource allocation may minimize an energy or power usage for a composition process for the layers of the current frame and subsequent frames having the same layers (e.g., subsequent frames received before the next geometry change 420). Because of the additional calculations necessary to optimize the resource allocation, the time interval 435 during which the second resource allocation is determined may extend beyond the next HW Vsync 440 and, in the absence of the first determination operation 431, may lead to video degradation (e.g., jank, frame skipping, etc.), as discussed in relation to FIG. 3B. Upon determining the second resource allocation, the execution of a composition process 437 for the plurality of layers in at least one subsequent frame (e.g., frames F2 and F3) may be initiated based on the second resource allocation. Using the first determination 431 and composition process 433 for a first frame after a geometry change and the second determination 435 and composition process 437 for subsequent frames may provide the benefit that frames are less likely to suffer from video degradation after a geometry change, as illustrated for frame F5 of FIG. 3B, while at the same time minimizing an energy or power usage at a device (e.g., device 104) for subsequent frames with the same geometry (e.g., layer structure and characteristics).

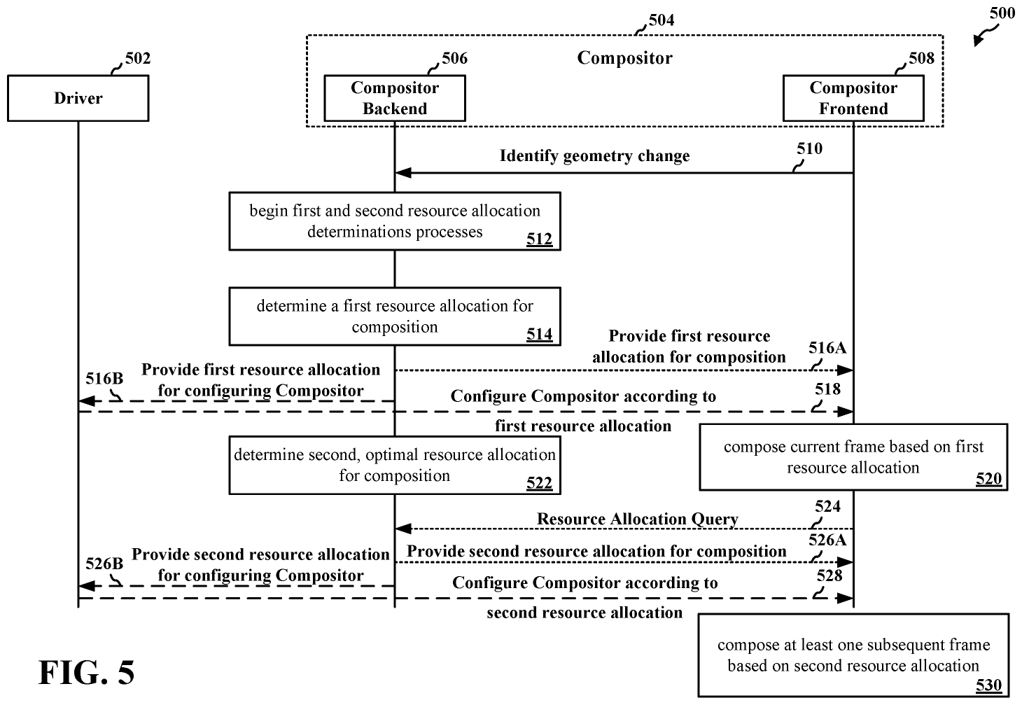

FIG. 5 is a call flow diagram 500 illustrating a set of operations performed by a compositor for composing a set of layers of a frame after a geometry change. Optional operations are indicated by dotted lines. FIG. 5 includes a driver 502 that in the illustrated configuration is responsible for configuring the compositor 504. Compositor 504 includes a compositor backend 506 and a compositor frontend 508. While the description below assigns particular operations to the compositor backend 506 and other particular operations to the compositor frontend 508, in other configurations a compositor may include a different set of components (e.g., more or fewer components) that perform the operations 510-530 illustrated in FIG. 5.

As illustrated in FIG. 5, a compositor 504 (at compositor frontend 508) identifies 510 a geometry change (to compositor backend 506). Identifying 510 the geometry change may include identifying an adjustment in one or more layers of a plurality of layers in a current frame compared to one or more layers of a plurality of layers in a previous frame. The adjustment in the one or more layers may include any of a change in the dimensions of a particular layer, a change in the number or identities (e.g., associated applications) of layers in the frame, or a change in a relative z-order of layers. The geometry change may be identified based on a comparison between one or more layers of a previous frame and one or more layers in a current frame. For example, in FIG. 4, the geometry change 420 is identified by a compositor for frames F1, F4, and F7 which each contain at least one layer that is different from the layers of a previous frame (e.g., F0, F3, and F6).

Upon identifying 510 the geometry change (e.g., at the compositor backend 506), the compositor 504 (or compositor backend 506) begins first and second resource allocation determination processes 512. The first and second allocation determination processes may determine a first, working resource allocation and a second, optimal resource allocation, respectively. For example, referring to FIG. 4, upon determining that there is a geometry change 420 at frame F1, a compositor (e.g., compositor 504) may initiate (1) the first resource allocation determination at the beginning of time interval 431 and (2) the second resource allocation determination at the beginning of time interval 435. As described, the first resource allocation determination of FIG. 4 may be fast and produce a first, working resource allocation that may not be optimal, while the second resource allocation determination may be slower and produce a second, optimal (e.g., power-optimal) resource allocation. The second, optimal resource allocation may be a resource allocation that is the most energy efficient, the fastest, or optimal in regard to some other measure or set of measures.

The compositor 504 (or compositor backend 506) may determine a first resource allocation 514 for composing the plurality of layers in the current frame (e.g., by completing the first resource allocation determination process). The first resource allocation may be a first, working resource allocation that can be determined quickly but may not be optimal. Upon determining the first resource allocation 514, in some aspects the compositor 504 (or compositor backend 506) may then provide 516A the first resource allocation to the compositor frontend 508 or driver 502 to configure the compositor 504 (or compositor frontend 508) to compose the layers of the current frame. In some aspects, upon determining the first resource allocation 514, the compositor 504 (or compositor backend 506) may then provide 516B the first resource allocation to driver 502 to configure 518 the compositor 504 (or compositor frontend 508) to compose the layers of the current frame. Driver 502 may be a component of a CPU that is used to control components of the compositor 504 (e.g., hardware or software components executing compositor component processes). The compositor 504 (or compositor frontend 508) may then compose 520 the layers of the current frame based on the first resource allocation.

The compositor 504 (or compositor backend 506) may then determine a second resource allocation 522 for composing the plurality of layers in the current frame (e.g., by completing the second resource allocation determination process). The second resource allocation may be a second, optimal resource allocation that may extend over a longer period of time. The second, optimal resource allocation may be a resource allocation that is the most energy efficient, the fastest, or optimal in regard to some other measure or set of measures. After determining the second resource allocation 522, the compositor 504 (e.g., compositor backend 506) may receive a query 524 for a resource allocation. Upon determining the second resource allocation 522 (or upon receiving the query 524), the compositor 504 (or compositor backend 506) may then provide 526A the second resource allocation to the compositor frontend 508 or driver 502 to configure the compositor 504 (or compositor frontend 508) to compose the layers of subsequent frames before a next geometry change. In some configurations, upon determining the second resource allocation 522 (or upon receiving the query 524), the compositor 504 (or compositor backend 506) may then provide 526B the second resource allocation to driver 502 to configure 528 the compositor 504 (or compositor frontend 508) to compose the layers of subsequent frames before a next geometry change. The compositor 504 (or compositor frontend 508) may then compose 530 the layers of at least one subsequent frame based on the second resource allocation.

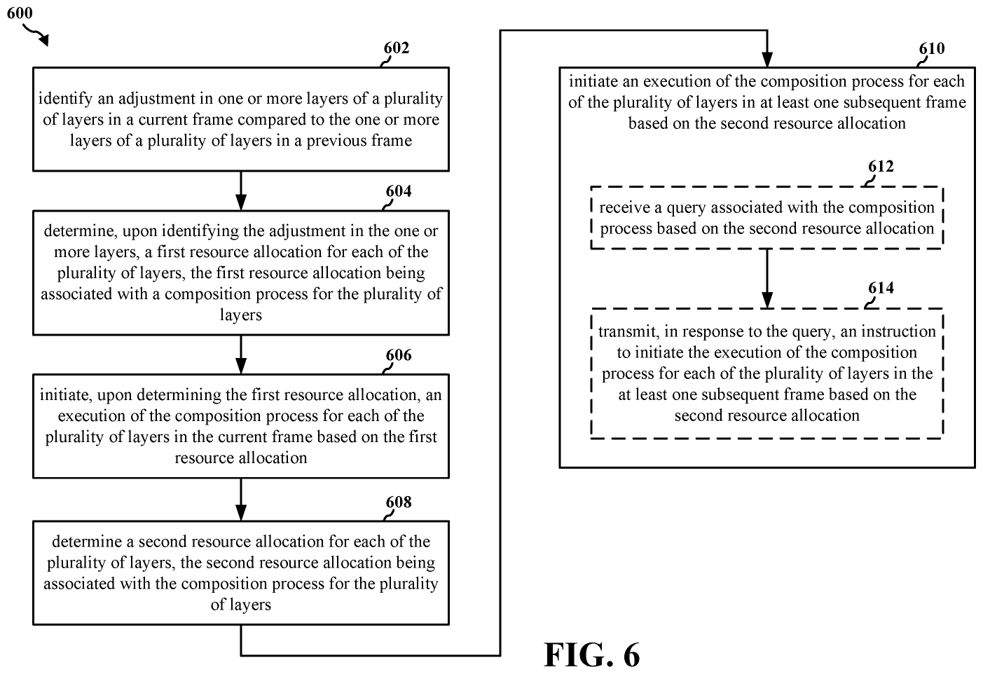

FIG. 6 is a flowchart 600 of an example method of display processing in accordance with one or more techniques of this disclosure. Optional operations are indicated by dotted lines. The method may be performed by an apparatus, such as an apparatus for display processing, a display processing unit (DPU) or other display processor, a compositor or compositor backend, a wireless communication device, and the like, as used in connection with the examples of FIGS. 1-5.

At 602, the apparatus may identify an adjustment in one or more layers of a plurality of layers in a current frame compared to one or more layers of a plurality of layers in a previous frame as described in connection with the examples in FIGS. 4 and 5. The identified adjustment in the one or more layers may be associated with at least one of a geometry change in the one or more layers, a dimension change in the one or more layers, a layer addition to the plurality of layers, a layer removal from the plurality of layers, a change in the set of applications associated with the plurality of layers, a change in the relative z-order of layers in the frame, a change in one or more properties of at least one display or at least one display endpoints, or an adjustment in an amount of the at least one display or the at least one display endpoints. A geometry change may include any of a change in the dimensions of a particular layer, a change in the number or identities (e.g., associated applications) of layers in the frame, or a change in relative z-order of layers. For example, referring to FIGS. 4 and 5, a compositor 504 (or compositor backend 506) may identify 510 an adjustment in one or more layers of a plurality of layers in a current frame compared to one or more layers of a plurality of layers in a previous frame (e.g., a geometry change). The identified adjustment may be any of the geometry changes 420 associated with frames F1, F4, and/or F7 of FIG. 4. Further, display processor 127 may perform step 602.

At 604, the apparatus may determine, upon identifying the adjustment in the one or more layers at 602, a first resource allocation for each of the plurality of layers for a composition process for the plurality of layers as described in connection with the examples in FIGS. 4 and 5. The first resource allocation determination at 604 may be a resource allocation based on a sortable characteristic of each layer of the plurality of layers. The sortable characteristic may be one of a size of each of the plurality of layers, an order (e.g., a z-order) of the plurality of layers, a dimension of the plurality of layers (e.g., a height, width, or area), a pixel format of the plurality of layers, or pixel metadata of the plurality of layers. For example, the first resource allocation may use the sortable characteristic to map (e.g., assign) each layer to a particular resource of a DPU (e.g., allocate a DPU pipe to each layer) until there are no DPU resources available and then begin allocating GPU or CPU (or other processor) resources to remaining layers. Clock bandwidth and other underlying resources may similarly be allocated based on a sortable characteristic and a first-come-first-served style algorithm. The first resource allocation may not be optimal (e.g., may not optimize power consumption) but may be less complex and, therefore, take less time to determine a working resource allocation than a resource allocation determination that determines an optimal resource allocation. The first resource allocation may be associated with a composition process for the plurality of layers, as described in connection with the examples in FIGS. 4 and 5. For example, referring to FIGS. 4 and 5, based upon identifying 510 an adjustment in the one or more layers (e.g., geometry change 420) for a particular frame (e.g., frame F1 of FIG. 4), a compositor 504 (or compositor backend 506) may determine at 514 a first resource allocation for composing each of the plurality of layers (e.g., during time interval 431). Further, display processor 127 may perform step 604.

At 606, the apparatus may initiate, upon determining the first resource allocation at 604, an execution of the composition process for each of the plurality of layers in the current frame based on the first resource allocation as described in connection with the examples in FIGS. 4 and 5. For example, referring to FIGS. 4 and 5, based upon determining 514 the first resource allocation for each of the plurality of layers (e.g., at the end of time interval 431 of FIG. 4), the compositor 504 (or compositor backend 506) may initiate an execution of the composition process (e.g., during time interval 433) based on the first resource allocation (e.g., by providing the first resource allocation 516 to a driver 502 for configuring the compositor to execute the composition process based on the first resource allocation 518). Based on the first resource allocation, a compositor 504 (or compositor frontend 508) may compose 520 the current frame (e.g., frame F1). Further, display processor 127 may perform step 606.

At 608, the apparatus may determine a second resource allocation for each of the plurality of layers for a composition process for the plurality of layers as described in connection with the examples in FIGS. 4 and 5. The second resource allocation determination at 608 may be a resource allocation based on a priority level of each layer of the plurality of layers. The priority level for each layer may be identified based on one or more factors that make composing the layer using a particular resource of the apparatus (e.g., a DPU, GPU, or CPU) more favorable (e.g., more power-efficient). Alternatively, or additionally, the second resource allocation may be determined based on the characteristics of the plurality of layers and the capabilities of the different resources of the apparatus (e.g., color-space conversion, tone mapping, scaling, etc.). The second, optimal resource allocation determination may be more complex and, therefore, take more time than the first, working resource allocation determination. For example, there may be a first level of decision regarding which layers to process at the DPU and which at a GPU (or other processor), a second level of decision regarding an allocation of DPU pipes to layers (a mapping of layers to pipes) based on layer and pipe characteristics/capabilities, and finally an allocation of DPU clock, bandwidth, and memory resources. The second resource allocation may be associated with a composition process for the plurality of layers, as described in connection with the examples in FIGS. 4 and 5. For example, referring to FIGS. 4 and 5, after identifying 510 an adjustment in the one or more layers (e.g., geometry change 420) for a particular frame (e.g., frame F1 of FIG. 4), a compositor 504 (or compositor backend 506) may determine at 522 a second resource allocation for composing each of the plurality of layers (e.g., during time interval 435). Further, display processor 127 may perform step 608.

At 610, the apparatus may initiate, upon determining the second resource allocation at 608, an execution of the composition process for each of the plurality of layers in at least one subsequent frame based on the second resource allocation as described in connection with the examples in FIGS. 4 and 5. For example, referring to FIGS. 4 and 5, based upon determining 522 the second resource allocation for each of the plurality of layers (e.g., at the end of time interval 435 of FIG. 4), the compositor 504 (or compositor backend 506) may initiate an execution of the composition process for a subsequent frame (e.g., a composition process for frame F2 during time interval 437) based on the second resource allocation (e.g., by providing the second resource allocation 526 to a driver 502 for configuring the compositor to execute the composition process based on the second resource allocation 528). Based on the second resource allocation, a compositor 504 (or compositor frontend 508) may compose 530 the subsequent frame (e.g., frame F2). Further, display processor 127 may perform step 610.

Initiating, at 610, the execution of the composition process for each of the plurality of layers in at least one subsequent frame based on the second resource allocation may include receiving, at 612, a query associated with the composition process based on the second resource allocation and transmitting, at 614, an instruction to initiate the execution of the composition process for each of the plurality of layers in the at least one subsequent frame based on the second resource allocation in response to the query at 612 as described in connection with the examples in FIGS. 4 and 5. The apparatus (e.g., a compositor backend) may receive, at 612, the query from a compositor component (e.g., a compositor frontend or driver) that will perform or control the composition. The query may include a query for a composition decision made by a compositor backend for subsequent frames after a first frame after a geometry change. The apparatus, in response to the query received at 612, may transmit (e.g., from the compositor backend to a compositor frontend of driver of the compositor frontend), at 614, an instruction to initiate the execution of the composition process for each of the plurality of layers in the at least one subsequent frame based on the second resource allocation in response to the query at 612. For example, referring to FIGS. 4 and 5, after determining 522 the second resource allocation for each of the plurality of layers (e.g., at the end of time interval 435 of FIG. 4), the compositor 504 (or compositor backend 506) may receive a query 524 for the determined second resource allocation. The compositor 504 (or compositor backend 506) may transmit the second resource allocation 526A or 526B to initiate an execution of the composition process for a subsequent frame (e.g., a composition process for frame F2 during time interval 437) based on the second resource allocation. For example, a compositor backend 506 may provide the second resource allocation 526B to a driver 502 for configuring the compositor (e.g., the compositor frontend 508) to execute the composition process based on the second resource allocation 528. Based on the second resource allocation, a compositor 504 (or compositor frontend 508) may compose 530 the subsequent frame (e.g., frame F2). Further, display processor 127 may perform steps 612 and 614.

In configurations, a method or an apparatus for display processing is provided. The apparatus may be a DPU, a display processor, or some other processor that may perform display processing. In aspects, the apparatus may be the display processor 127 within the device 104, or may be some other hardware within the device 104 or another device. The apparatus may include means for identifying an adjustment in one or more layers of a plurality of layers in a current frame compared to one or more layers of the plurality of layers in a previous frame determining, upon identifying the adjustment in the one or more layers, a first resource allocation for each of the plurality of layers, the first resource allocation being associated with a composition process for the plurality of layers. The apparatus may further include means for determining, upon identifying the adjustment in the one or more layers, a first resource allocation for each of the plurality of layers, the first resource allocation being associated with a composition process for the plurality of layers. The apparatus may further include means for determining, after the determination of the first resource allocation begins, a second resource allocation for each of the plurality of layers, the second resource allocation being associated with the composition process for the plurality of layers. The apparatus may further include means for initiating, upon determining the first resource allocation, an execution of the composition process for each of the plurality of layers in the current frame based on the first resource allocation. The apparatus may further include means for initiating, upon determining the second resource allocation, an execution of the composition process for each of the plurality of layers in at least one subsequent frame based on the second resource allocation. The apparatus may further include means for receiving a query associated with the composition process based on the second resource allocation, and the execution of the composition process for each of the plurality of layers in the at least one subsequent frame based on the second resource allocation may be initiated based on the query. The apparatus may further include means for transmitting, in response to the query, an instruction for the execution of the composition process for each of the plurality of layers in the at least one subsequent frame based on the second resource allocation.

The subject matter described herein can be implemented to realize one or more benefits or advantages. For instance, the described graphics processing techniques can be used by a GPU, a CPU, a DPU, or some other processor that can perform display processing to implement the incremental overlay resource allocation (or phased composition strategy) techniques described herein to achieve jank-free and near-power-optimal overlay resource allocation without increasing the computational resources necessary to calculate a power-optimal overlay resource allocation.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interrupted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of display processing, characterized by: identifying an adjustment in one or more layers of a plurality of layers in a current frame compared to the one or more layers of the plurality of layers in a previous frame; determining, upon identifying the adjustment in the one or more layers, a first resource allocation for each of the plurality of layers, the first resource allocation being associated with a composition process for the plurality of layers; determining, after the determination of the first resource allocation begins, a second resource allocation for each of the plurality of layers, the second resource allocation being associated with the composition process for the plurality of layers; initiating, upon determining the first resource allocation, an execution of the composition process for each of the plurality of layers in the current frame based on the first resource allocation; and initiating, upon determining the second resource allocation, an execution of the composition process for each of the plurality of layers in at least one subsequent frame based on the second resource allocation.

Aspect 2 may be combined with aspect 1 and is characterized in that the second resource allocation for each of the plurality of layers is determined based on a priority level of each of the plurality of layers.

Aspect 3 may be combined with aspect 2 and is characterized in that at least one layer of the plurality of layers including a highest priority level is associated with the execution of the composition process at a DPU.

Aspect 4 may be combined with any of aspects 1-3 and is characterized in that the first resource allocation for each of the plurality of layers is determined based on at least one of a size of the plurality of layers, an order of the plurality of layers, a dimension of the plurality of layers, a pixel format of the plurality of layers, or pixel metadata of the plurality of layers.

Aspect 5 may be combined with any of aspects 1-4 further characterized by receiving a query associated with the composition process based on the second resource allocation, characterized in that the execution of the composition process for each of the plurality of layers in the at least one subsequent frame based on the second resource allocation is initiated based on the query.

Aspect 6 may be combined with aspect 5 and is characterized in that initiating the execution of the composition process for each of the plurality of layers in the at least one subsequent frame based on the second resource allocation is further characterized by transmitting, in response to the query, an instruction for the execution of the composition process for each of the plurality of layers in the at least one subsequent frame based on the second resource allocation.

Aspect 7 may be combined with any of aspects 1-6 and is characterized in that the first resource allocation and the second resource allocation are associated with a composition location for each of the plurality of layers

Aspect 8 may be combined with aspect 7 and is characterized in that the composition location for each of the plurality of layers corresponds to a DPU, GPU, a CPU, firmware, or at least one processor.

Aspect 9 may be combined with any of aspects 1-8 and is characterized in that the execution of the composition process for at least one layer of the plurality of layers is associated with one or more overlay resources at a DPU, and characterized in that the execution of the composition process for at least one other layer of the plurality of layers is associated with one or more resources at a GPU.

Aspect 10 may be combined with aspect 9 and is characterized in that the at least one layer is mapped to the one or more overlay resources at the DPU, and characterized in that the at least one other layer is mapped to the one or more resources at the GPU.

Aspect 11 may be combined with any of aspects 9 and 10 and is characterized in that the at least one layer for the composition process based on the second resource allocation is different from the at least one layer for the composition process based on first resource allocation.

Aspect 12 may be combined with any of aspects 9 and 11 and is characterized in that the one or more overlay resources at the DPU correspond to at least one of one or more fixed resources, one or more hardware blocks, or one or more pipes.

Aspect 13 may be combined with any of aspects 1-12 and is characterized in that the execution of the composition process based on the second resource allocation is initiated corresponding to a Vsync signal of the at least one subsequent frame.

Aspect 14 may be combined with any of aspects 1-13 and is characterized in that the adjustment in the one or more layers is associated with at least one of a geometry change in the one or more layers, a dimension change in the one or more layers, a layer addition to the plurality of layers, a change in one or more properties of at least one display or at least one display endpoints, or an adjustment in an amount of the at least one display or the at least one display endpoints.

Aspect 15 may be combined with any of aspects 1-14 and is characterized in that the first resource allocation and the second resource allocation are associated with at least one of one or more clock values, one or more bandwidth values, one or more register values, one or more interrupt line values, or one or more specialized processor values.

Aspect 16 may be combined with aspect 15 and is characterized in that the one or more clock values correspond to a memory clock, a system clock, or a pixel clock, and characterized in that the one or more bandwidth values correspond to a memory bandwidth, a system bandwidth, or a pixel bandwidth.

Aspect 17 is an apparatus for display processing including at least one processor coupled to a memory and configured to implement a method as in any of aspects 1 to 16.

Aspect 18 is an apparatus for display processing including means for implementing a method as in any of aspects 1 to 16.

Aspect 19 is a computer-readable medium storing computer executable code, the code when executed by at least one processor causes the at least one processor to implement a method as in any of aspects 1 to 16.

What is claimed is:

1. A method of display processing, comprising:
identifying an adjustment in one or more layers of a plurality of layers in a current frame compared to the one or more layers of the plurality of layers in a previous frame;
determining, upon identifying the adjustment in the one or more layers, a first resource allocation for each of the plurality of layers, the first resource allocation being associated with a composition process for the plurality of layers;
determining, after the determination of the first resource allocation begins, a second resource allocation for each of the plurality of layers, the second resource allocation being associated with the composition process for the plurality of layers;
initiating, upon determining the first resource allocation, an execution of the composition process for each of the plurality of layers in the current frame based on the first resource allocation; and
initiating, upon determining the second resource allocation, an execution of the composition process for each of the plurality of layers in at least one subsequent frame based on the second resource allocation.

2. The method of claim 1, wherein the second resource allocation for each of the plurality of layers is determined based on a priority level of each of the plurality of layers.

3. The method of claim 2, wherein at least one layer of the plurality of layers including a highest priority level is associated with the execution of the composition process at a display processing unit (DPU).

4. The method of claim 1, wherein the first resource allocation for each of the plurality of layers is determined based on at least one of a size of the plurality of layers, an order of the plurality of layers, a dimension of the plurality of layers, a pixel format of the plurality of layers, or pixel metadata of the plurality of layers.

5. The method of claim 1, further comprising:
receiving a query associated with the composition process based on the second resource allocation, wherein the execution of the composition process for each of the plurality of layers in the at least one subsequent frame based on the second resource allocation is initiated based on the query.

6. The method of claim 5, wherein initiating the execution of the composition process for each of the plurality of layers in the at least one subsequent frame based on the second resource allocation comprises:
transmitting, in response to the query, an instruction for the execution of the composition process for each of the plurality of layers in the at least one subsequent frame based on the second resource allocation.

7. The method of claim 1, wherein the first resource allocation and the second resource allocation are associated with a composition location for each of the plurality of layers.

8. The method of claim 7, wherein the composition location for each of the plurality of layers corresponds to a display processing unit (DPU), a graphics processing unit (GPU), a central processing unit (CPU), firmware, or at least one processor.

9. The method of claim 1, wherein the execution of the composition process for at least one layer of the plurality of layers is associated with one or more overlay resources at a display processing unit (DPU), and wherein the execution of the composition process for at least one other layer of the plurality of layers is associated with one or more resources at a graphics processing unit (GPU).

10. The method of claim 9, wherein the at least one layer is mapped to the one or more overlay resources at the DPU, and wherein the at least one other layer is mapped to the one or more resources at the GPU.

11. The method of claim 9, wherein the at least one layer for the composition process based on the second resource allocation is different from the at least one layer for the composition process based on first resource allocation.

12. The method of claim 9, wherein the one or more overlay resources at the DPU correspond to at least one of one or more fixed resources, one or more hardware blocks, or one or more pipes.

13. The method of claim 1, wherein the execution of the composition process based on the second resource allocation is initiated corresponding to a vertical synchronization (Vsync) signal of the at least one subsequent frame.

14. The method of claim 1, wherein the adjustment in the one or more layers is associated with at least one of a geometry change in the one or more layers, a dimension change in the one or more layers, a layer addition to the plurality of layers, a change in one or more properties of at least one display or at least one display endpoints, or an adjustment in an amount of the at least one display or the at least one display endpoints.

15. The method of claim 1, wherein the first resource allocation and the second resource allocation are associated with at least one of one or more clock values, one or more bandwidth values, one or more register values, one or more interrupt line values, or one or more specialized processor values.

16. The method of claim 15, wherein the one or more clock values correspond to a memory clock, a system clock, or a pixel clock, and wherein the one or more bandwidth values correspond to a memory bandwidth, a system bandwidth, or a pixel bandwidth.

17. An apparatus for display processing, comprising:
a memory; and
at least one processor coupled to the memory and configured to:
identify an adjustment in one or more layers of a plurality of layers in a current frame compared to one or more layers of a plurality of layers in a previous frame;
determine, upon identifying the adjustment in the one or more layers, a first resource allocation for each of the plurality of layers, the first resource allocation being associated with a composition process for the plurality of layers;
determine, after the determination of the first resource allocation begins, a second resource allocation for each of the plurality of layers, the second resource allocation being associated with the composition process for the plurality of layers;
initiate, upon determining the first resource allocation, an execution of the composition process for each of the plurality of layers in the current frame based on the first resource allocation; and
initiate, upon determining the second resource allocation, an execution of the composition process for each of the plurality of layers in at least one subsequent frame based on the second resource allocation.

18. The apparatus of claim 17, wherein the at least one processor is further configured to:
receive a query associated with the composition process based on the second resource allocation, wherein the execution of the composition process for each of the plurality of layers in the at least one subsequent frame based on the second resource allocation is initiated based on the query; and
transmit, in response to the query, an instruction for the execution of the composition process for each of the plurality of layers in the at least one subsequent frame based on the second resource allocation to initiate the execution of the composition process for each of the plurality of layers in the at least one subsequent frame based on the second resource allocation.

19. The apparatus of claim 17, wherein the first resource allocation and the second resource allocation are associated with a composition location for each of the plurality of layers, the composition location for each of the plurality of layers corresponding to a display processing unit (DPU), a graphics processing unit (GPU), a central processing unit (CPU), firmware, or at least one processor.

20. The apparatus of claim 17, wherein the execution of the composition process for at least one layer of the plurality of layers is associated with one or more overlay resources at a display processing unit (DPU), wherein the execution of the composition process for at least one other layer of the plurality of layers is associated with one or more resources at a graphics processing unit (GPU), and wherein the at least one layer for the composition process based on the second resource allocation is different from the at least one layer for the composition process based on first resource allocation.

21. The apparatus of claim 20, wherein the at least one layer is mapped to the one or more overlay resources at the DPU, and wherein the at least one other layer is mapped to the one or more resources at the GPU.

22. The apparatus of claim 20, wherein the one or more overlay resources at the DPU correspond to at least one of one or more fixed resources, one or more hardware blocks, or one or more pipes.

23. The apparatus of claim 17, wherein the first resource allocation and the second resource allocation are associated with at least one of one or more clock values, one or more bandwidth values, one or more register values, wherein one or more interrupt line values, or one or more specialized processor values, the one or more clock values correspond to a memory clock, a system clock, or a pixel clock, and wherein the one or more bandwidth values correspond to a memory bandwidth, a system bandwidth, or a pixel bandwidth.

24. The apparatus of claim 17, wherein the second resource allocation for each of the plurality of layers is determined based on a priority level of each of the plurality of layers.

25. The apparatus of claim 24, wherein at least one layer of the plurality of layers including a highest priority level is associated with the execution of the composition process at a display processing unit (DPU).

26. The apparatus of claim 17, wherein the first resource allocation for each of the plurality of layers is determined based on at least one of a size of the plurality of layers, an order of the plurality of layers, a dimension of the plurality of layers, a pixel format of the plurality of layers, or pixel metadata of the plurality of layers.

27. The apparatus of claim 17, wherein the execution of the composition process based on the second resource allocation is initiated corresponding to a vertical synchronization (Vsync) signal of the at least one subsequent frame.

28. The apparatus of claim 17, wherein the adjustment in the one or more layers is associated with at least one of a geometry change in the one or more layers, a dimension change in the one or more layers, a layer addition to the plurality of layers, a change in one or more properties of at least one display or at least one display endpoints, or an adjustment in an amount of the at least one display or the at least one display endpoints.

29. An apparatus for display processing, comprising:
means for identifying an adjustment in one or more layers of a plurality of layers in a current frame compared to one or more layers of a plurality of layers in a previous frame;
means for determining, upon identifying the adjustment in the one or more layers, a first resource allocation for each of the plurality of layers, the first resource allocation being associated with a composition process for the plurality of layers;
means for determining after the determination of the first resource allocation begins, a second resource allocation for each of the plurality of layers, the second resource allocation being associated with the composition process for the plurality of layers;
means for initiating, upon determining the first resource allocation, an execution of the composition process for each of the plurality of layers in the current frame based on the first resource allocation; and
means for initiating, upon determining the second resource allocation, an execution of the composition process for each of the plurality of layers in at least one subsequent frame based on the second resource allocation.

30. A computer-readable medium storing computer executable code for display processing, the code when executed by a processor causes the processor to:
identify an adjustment in one or more layers of a plurality of layers in a current frame compared to one or more layers of a plurality of layers in a previous frame;
determine, upon identifying the adjustment in the one or more layers, a first resource allocation for each of the plurality of layers, the first resource allocation being associated with a composition process for the plurality of layers;
determine, after the determination of the first resource allocation begins, a second resource allocation for each of the plurality of layers, the second resource allocation being associated with the composition process for the plurality of layers;
initiate, upon determining the first resource allocation, an execution of the composition process for each of the plurality of layers in the current frame based on the first resource allocation; and
initiate, upon determining the second resource allocation, an execution of the composition process for each of the plurality of layers in at least one subsequent frame based on the second resource allocation.
